(19) United States
(12) Patent Application Publication
(10) Pub. No.: US 2026/0245151 A1
(43) Pub. Date: Aug. 20, 2026

(54) Systems and Methods for Automated Network Upgrade Costs for Generators

(71) Applicant: Inventus Holdings, LLC, Juno Beach, FL (US)

(72) Inventors: Cody Lionel Doll, Lakeville, MN (US); Benjamin D. Grindy, Minneapolis, MN (US); Phou Lee, Apple Valley, MN (US); Aaron P. Bloom, Mahtomedi, MN (US); Arun Sreenivasan Madhavan, Saint Paul, MN (US); Stephen P. Florentino, Blaine, MN (US); Lowell C. Savage, III, Woodbury, MN (US); Timothy J. Kudalis, Juno Beach, FL (US); Brent Demark, Juno Beach, FL (US)

(21) Appl. No.: 19/058,923

(22) Filed: Feb. 20, 2025

(51) Int. Cl. G06Q 50/06; G06Q 10/0631

(52) U.S. Cl. CPC G06Q 50/06; G06Q 10/06315

(57) ABSTRACT

The disclosed technology includes systems and methods for determining network upgrade costs of a renewable energy project for an electricity generator. An example method can include selecting a region of an electric grid and receiving power flow data for the region. The method can include determining at least one overloaded electrical component based at least in part on the power flow data. The method can further include determining a network upgrade cost for the overloaded electrical component. The network upgrade cost can be based on one or more location-specific rules and electrical component upgrade cost data. The method can include generating a cost table based on the network upgrade cost. The disclosed technology can include a system configured to implement any embodiments of the methods for determining the network upgrade costs discussed herein.

### FIELD OF THE DISCLOSURE

The various embodiments of the present disclosure relate generally to systems and methods of determining network upgrade costs for electricity generators, and more particularly to automatically generating network upgrade costs for an electricity generator within a region based on power flow data.

### BACKGROUND

An electric grid can include a network of substations, buses, and electrical components that transmit and regulate power between electric grid elements. Electrical components can include transmission lines that transfer power between power generators, buses, substations, offtaker sites, and other electric grid elements. A grid operator, such as an independent system operator (ISO) or a regional transmission organization (RTO), regulates the transmission, sale, and output of power within different regions of an electric grid. The grid operator and/or a transmission provider may have authority to approve new power generation projects based on loads and capacities of the electric grid.

When a new project is submitted to a grid operator or transmission provider to be implemented in the electric grid, the grid operator or transmission provider calculates the necessary network upgrade costs for the project to be installed. Often, renewable energy projects, which could have been otherwise successful at a particular location, will be halted, or delayed, by the electricity generator or project owner from the queue due to high and unexpected network upgrade costs assessed to the renewable energy project by the grid operator or transmission provider. Traditionally, electricity generators, or project owners, will analyze some form of load flow analysis and determine which potential sites for a new project have enough capacity to assume that there would be little to no network upgrade costs for electrical components associated with the potential site if the project was to be accepted by the transmission provider in the queue. These traditional methods can be overly conservative, and may limit the number of potential locations for renewable energy sites while ignoring possible sites due to anticipated, but uncalculated, risk for necessary upgrade costs.

Accordingly, there is a need for improved systems and methods for determining network upgrade costs for an energy project of an electricity generator. Embodiments of the present disclosure are directed to this and other considerations.

### BRIEF SUMMARY

An exemplary embodiment of the present disclosure provides a method for determining upgrade costs of overloaded components for an electricity generator, including: selecting a region of an electric grid, the region comprising at least one transmission area; receiving power flow data for the region; receiving electrical component upgrade cost data for the region; receiving location-specific rules for the at least one transmission area; determining which electrical components operating at least partially within the region are overloaded electrical components based at least in part on the power flow data; determining a network upgrade cost for at least one overloaded electrical component of the region for the electricity generator; and generating a table comprising the network upgrade cost. The network upgrade cost can be based at least in part on the electrical component upgrade cost data and the location-specific rules.

In any of the embodiments disclosed herein, the region can be selected from a group consisting of an independent system operator (ISO) region, a regional transmission authority (RTO) region, an electricity generator-owned region, and a transmission provider region.

In any of the embodiments disclosed herein, the location-specific rules for the at least one transmission area can include a capacity rule defining a capacity threshold for an electrical component to be an overloaded electrical component; and a funding rule defining if an overloaded electrical component requires funding from the electricity generator.

In any of the embodiments disclosed herein, determining a network upgrade cost for at least one overloaded electrical component can include determining if at least one overloaded electrical component requires funding from the electricity generator based at least in part on the funding rule; and determining the network upgrade cost for the at least one overloaded electrical component based at least in part on a pro rata share of power at the at least one overloaded component from the electricity generator.

In any of the embodiments disclosed herein, wherein the power flow data can include one or more electrical bus locations; one or more electrical bus voltages; and one or more power flows. Determining which electrical components operating at least partially within the region are overloaded electrical components can include determining an electrical component type based at least in part on the one or more electrical bus locations and the one or more electrical bus voltages; and determining an overloaded electrical component based at least in part on the one or more power flows and the electrical component type.

In any of the embodiments disclosed herein, the method can further include receiving a project capacity.

In any of the embodiments disclosed herein, the method can further include generating a graphical interface displaying a geographical map. The geographical map can include one or more electrical bus locations and one or more indicators at the one or more electrical bus locations. The one or more indicators can be based at least in part on the network upgrade cost.

In any of the embodiments disclosed herein, the method can further include selecting a location for a renewable energy project based at least in part on the project capacity and the network upgrade cost. The network upgrade cost can be determined further based at least in part on the project capacity.

An exemplary embodiment of the present disclosure provides a system including one or more processors; and memory including instructions that when executed by the one or more processors, can cause the one or more processors to: select a region of an electric grid, the region including at least one transmission area; receive power flow data for the region including: one or more electrical bus locations; one or more electrical bus voltages; and one or more power flows; receive electrical component upgrade cost data for the region; receive location-specific rules for the at least one transmission area; determine which electrical components operating at least partially within the region are overloaded electrical components based at least in part on the power flow data; determine a network upgrade cost for at least one overloaded electrical component of the region for an electricity generator, the network upgrade cost based at least in part on the electrical component upgrade cost data and the location-specific rules; and generate a table comprising the network upgrade cost.

In any of the embodiments disclosed herein, the region can be selected from a group consisting of an independent system operator (ISO) region, a regional transmission authority (RTO) region, an electricity generator-owned region, and a transmission provider region.

In any of the embodiments disclosed herein, the location-specific rules for the at least one transmission area can include: a capacity rule defining a capacity threshold for an electrical component to be an overloaded electrical component; and a funding rule defining if an overloaded electrical component requires funding from the electricity generator.

In any of the embodiments disclosed herein, determining a network upgrade cost for at least one overloaded electrical component can include: determining if at least one overloaded electrical component requires funding from the electricity generator based at least in part on the funding rule; and determining the network upgrade cost for the at least one overloaded electrical component based at least in part on a pro rata share of power at the at least one overloaded component from the electricity generator.

In any of the embodiments disclosed herein, determining which electrical components operating at least partially within the region are overloaded electrical components can include determining an electrical component type based at least in part on the one or more electrical bus locations and the one or more electrical bus voltages; and determining an overloaded electrical component based at least in part on the one or more power flows and the electrical component type.

In any of the embodiments disclosed herein, the instructions, when executed by the one or more processors, can further cause the one or more processors to: receive a project capacity; and generate a graphical interface displaying a geographical map. The geographical map can include one or more electrical bus locations and one or more indicators at the one or more electrical bus locations. The one or more indicators can be based at least in part on the network upgrade cost.

In any of the embodiments disclosed herein, the instructions, when executed by the one or more processors, can further cause the one or more processors to select a location for a renewable energy project based at least in part on a project capacity and the network upgrade cost. The network upgrade cost can be determined further based at least in part on the project capacity.

An exemplary embodiment of the present disclosure provides a method including selecting a region of an electric grid; receiving power flow data for the region; determining an overloaded electrical component of a plurality of electrical components disposed at least partially in the region based at least in part on the power flow data; determining a network upgrade cost for the overloaded electrical component; determining a queue viability metric of a renewable energy project from an electrical generator based at least in part on the network upgrade cost; and removing the renewable energy project from a project queue based at least in part on the queue viability metric.

In any of the embodiments disclosed herein, the overloaded electrical component can be part of a plurality of overloaded electrical components. Determining the network upgrade cost for the overloaded electrical component can include determining a total network upgrade cost for the plurality of overloaded electrical components.

In any of the embodiments disclosed herein, the queue viability metric can be determined based at least in part on the total network upgrade cost.

In any of the embodiments disclosed herein, the region can include one or more transmission areas. The one or more transmission areas can include one or more location-specific rules. The network upgrade cost can be determined based at least in part on the one or more location-specific rules.

In any of the embodiments disclosed herein, determining a network upgrade cost for the overloaded electrical component can include determining if at least one overloaded electrical component requires funding from the electricity generator based at least in part on the one or more location-specific rules; and determining the network upgrade cost for the overloaded electrical component based at least in part on a pro rata share of power at the overloaded component from the electricity generator.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates an example system for determining network upgrade costs for an electricity generator, in accordance with examples of the disclosed technology.

FIG. 2 illustrates an example computing device configured to determine network upgrade costs for an electricity generator, in accordance with examples of the disclosed technology.

FIG. 3 is a flow diagram illustrating an exemplary method of determining network upgrade costs for an electricity generator, in accordance with examples of the disclosed technology.

FIG. 4 is another flow diagram illustrating an exemplary method of determining network upgrade costs for an electricity generator, in accordance with examples of the disclosed technology.

FIG. 5. is yet another flow diagram illustrating an exemplary method of determining network upgrade costs for an electricity generator, in accordance with examples of the disclosed technology.

FIG. 6 is yet another flow diagram illustrating an exemplary method of determining network upgrade costs for an electricity generator, in accordance with examples of the disclosed technology.

FIG. 7 is yet another flow diagram illustrating an exemplary method of determining network upgrade costs for an electricity generator, in accordance with examples of the disclosed technology.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Although various aspects of the disclosed technology are explained in detail herein, it is to be understood that other aspects of the disclosed technology are contemplated. Accordingly, it is not intended that the disclosed technology is limited in its scope to the details of construction and arrangement of components expressly set forth in the following description or illustrated in the drawings. The disclosed technology can be implemented and practiced or carried out in various ways. In particular, the presently disclosed subject matter is described in the context of being systems and methods for generating network upgrade costs. The present disclosure, however, is not so limited, and can be applicable in other contexts in which data is provided by a human and entered into a computing system. For example, the disclosed technology can be applicable to systems in which a human can enter data via a keyboard, a mouse, a microphone (e.g., interactive voice response (IVR)), or other devices configured to provide data from a human to a computing system. Accordingly, when the present disclosure is described in the context of systems and methods for determining network upgrade costs for an electricity generator, it will be understood that other implementations can take the place of those referred to.

It should also be noted that, as used in the specification and the appended claims, the singular forms “a,” “an,” and “the” include plural references unless the context clearly dictates otherwise. References to a composition containing “a” constituent is intended to include other constituents in addition to the one named.

Also, in describing the disclosed technology, terminology will be resorted to for the sake of clarity. It is intended that each term contemplates its broadest meaning as understood by those skilled in the art and includes all technical equivalents which operate in a similar manner to accomplish a similar purpose.

Ranges may be expressed herein as from “about” or “approximately” or “substantially” one particular value and/or to “about” or “approximately” or “substantially” another particular value. When such a range is expressed, the disclosed technology can include from the one particular value and/or to the other particular value. Further, ranges described as being between a first value and a second value are inclusive of the first and second values. Likewise, ranges described as being from a first value and to a second value are inclusive of the first and second values.

Herein, the use of terms such as “having,” “has,” “including,” or “includes” are open-ended and are intended to have the same meaning as terms such as “comprising” or “comprises” and not preclude the presence of other structure, material, or acts. Similarly, though the use of terms such as “can” or “may” are intended to be open-ended and to reflect that structure, material, or acts are not necessary, the failure to use such terms is not intended to reflect that structure, material, or acts are essential. To the extent that structure, material, or acts are presently considered to be essential, they are identified as such.

It is also to be understood that the mention of one or more method steps does not preclude the presence of additional method steps or intervening method steps between those steps expressly identified. Moreover, although the term “step” can be used herein to connote different aspects of methods employed, the term should not be interpreted as implying any particular order among or between various steps herein disclosed unless and except when the order of individual steps is explicitly required. Further, the disclosed technology does not necessarily require all steps included in the methods and processes described herein. That is, the disclosed technology includes methods that omit one or more steps expressly discussed with respect to the methods described herein.

As used herein, the term “electrical component” can include any electric grid element that contributes to or affects the transmission or distribution of electric power in an electric grid. As non-limiting examples, electrical components can include transmission lines, circuit breakers, transformers, and any electrical device having a role in the electric grid of a similar context.

As used herein, the term “overloaded” or “overloaded electrical component” can include any electrical component that is subject to a load or current above a defined threshold. The defined threshold for an overloaded electrical component can be set by a grid operator, energy generation site, electricity generator, generator, project owner, transmission provider, or any other transmission authority. Further, the defined threshold may vary between different substations, buses, ISOs, RTOs, states, provinces, or regions.

As used herein, the term “substation” can include any electric grid element that is configured to transmit and/or distribute electric power within the electric grid. As a non-limiting example, a substation can regulate and stabilize voltage levels at different nodes within an electric grid. A substation may transform, step up, or step down voltages between transmission lines of the electric grid.

As used herein, the term “electrical bus” or “bus” can include any node within an electric grid that forms an interconnection point between multiple electrical components, substations, generation points, load points, or similar electric grid elements understood herein.

As used herein, the term “grid operator” can include any entity associated with the coordination, control, or monitoring of the electric grid. As non-limiting examples, a grid operator can include an independent system operator (ISO), a regional transmission organization (RTO), and any entities of similar authority known in the art.

As used herein, the term “transmission provider” can include any entity with the authority to accept or reject energy generation projects from an interconnection queue (referred to herein as a “queue”), or generally to accept or reject the installation of new generation sources into the electric grid. A transmission provider can include any entity that manages or has authority over a generator interconnection queue.

As used herein, the term “electricity generator” or “generator” can include any entity which owns, manages, or develops an energy generation project or an energy generation source. As a non-limiting example, an electricity generator can include any entity that owns, manages, or develops a renewable energy project. In some non-limiting examples, an electricity generator can submit a renewable energy project to a queue of a transmission provider for approval.

Reference will now be made in detail to example embodiments of the disclosed technology that are illustrated in the accompanying drawings and disclosed herein. Wherever convenient, the same reference numbers will be used throughout the drawings to refer to the same or like parts.

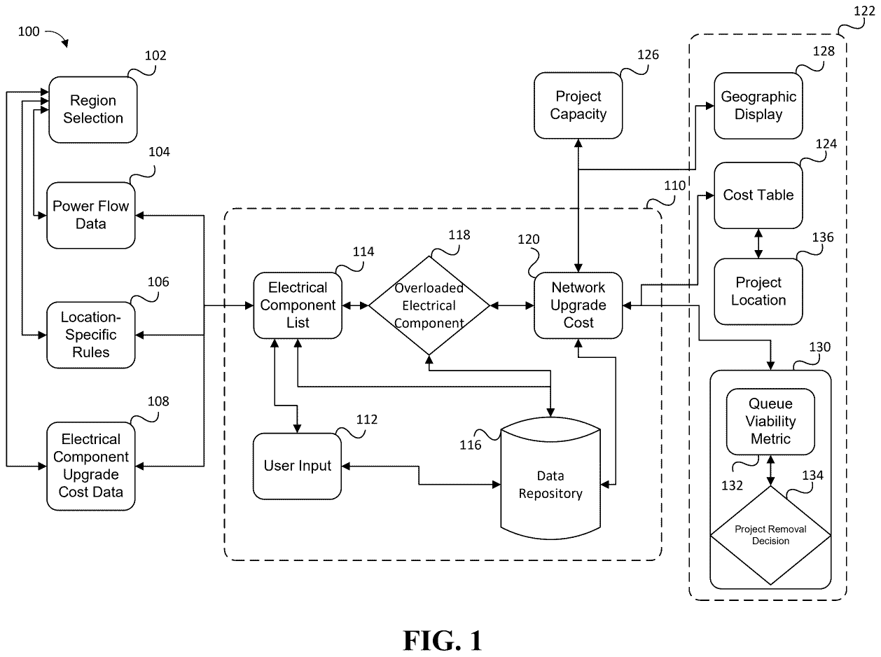

FIG. 1 illustrates an example system 100 for determining network upgrade costs for an electricity generator. One of skill in the art will appreciate that the various features of the system 100 described herein can be incorporated into a single computing device or be divided into distinct parts across a network of computing devices. Thus, although the various features of the system 100 may be described as separate and distinct features or components, the described technology is not so limited.

The system 100 can include a region selection 102. As can be appreciated, the region selection 102 can include a program or interface configured to allow a user to select a region within an electric grid to be analyzed. The region, in some embodiments, can include a geographic area of the electric grid, and corresponding electric grid elements, defined by an ISO. In some embodiments, the region can include a geographic area of the electric grid, and corresponding electric grid elements, defined by an RTO. That is, the region to be analyzed as a result of the region selection 102 can include any area associated with a grid operator. In some embodiments, the region selection 102 can be based on geographic areas associated with a transmission provider. In some embodiments, the region can be a region under the authority of a single transmission provider.

In some embodiments, the region can include any combination of substations, buses, electrical components, and the like within an electric grid. The region, in some embodiments, can include a substation and each electrical component connected to the substation. In some embodiments, the region can include an electrical bus, and each electrical component connected to the electrical bus. The region may span between multiple transmission provider regions, grid operator regions, ISOs, or RTOs. The region selection 102 can be executed via user input, such that a user may manually select a region. In some embodiments, the region selection 102 can be automatic, such that the system 100 can be configured to automatically select the region based at least in part on a project for the electricity generator. The region can include at least one transmission area, such that a transmission area can define a geographic area located at least partially within the region. For example, a transmission area may be characterized as a collection of electric grid elements within the region selected via the region selection 102 that are governed by the same laws and/or regulations, follow similar power trade trends, or similar contexts as understood herein. Specifically, in some embodiments, a transmission area can include electric grid elements subject to the same rules and regulations for new project approval, overload threshold, overload funding allocation, or any combination thereof. That is, the transmission area can include a region defined by a project queue managed by a transmission provider. In this way, the transmission area can be based at least in part on a geographic area defined by a transmission provider. The region can be selected from a group consisting of an ISO, an RTO, an electricity generator-owned region, a transmission provider region, a region associated with a project queue, and a grid operator region.

The system 100 can be configured to receive power flow data 104. In some embodiments, the electricity generator can produce the power flow data 104. In some embodiments, the electricity generator can receive the power flow data 104 from a third party, such as a grid operator or transmission provider. The power flow data 104 can be associated with the region selection 102, such that the power flow data 104 is representative of the electric grid elements operating at least partially within the region of the region selection 102. That is, the power flow data 104 can be representative of voltage and/or current characteristics of electric grid elements located at least partially within the region selected by the region selection 102.

The system 100 can be configured to receive location-specific rules 106. As can be appreciated, the location-specific rules 106 can include one or more rules associated with a particular location of the electric grid. Specifically, the location-specific rules 106 can be associated with a particular location disposed at least partially within the region selected via the region selection 102. Further, the location-specific rules 106 can include location-specific rules for a transmission area of the region. That is, the location-specific rules 106 can include rules from a transmission provider of the region. In this way, the location-specific rules 106 can be defined by the one or more transmission providers of the region. The location-specific rules 106 can include rules defining multiple transmission areas of the region. The location-specific rules 106 can include location-specific rules for each transmission area of the region. In this way, during analysis, relevant rules for determining network upgrade costs can be tailored to the transmission area where each electric grid element is located.

The location-specific rules 106 can include a capacity rule defining a capacity threshold for an electrical component to be considered an overloaded electrical component. The location-specific rules 106 can include a funding rule defining if an overloaded electrical component requires funding from the electricity generator, such that the funding rule can outline when a particular electricity generator is required to owe an upgrade cost for an overloaded electrical component. The capacity rule and the funding rule will be described in greater detail herein.

The system 100 can be configured to receive electrical component upgrade cost data 108. The electrical component upgrade cost data 108 can include upgrade costs for electrical components of the region selected via the region selection 102. That is, the electrical component upgrade cost data 108 can be specific to a region, such that the system 100 can be configured to determine the electrical component upgrade cost data associated with the region of the electrical component upgrade cost data 108. The electrical component upgrade cost data 108 can include different prices, or upgrade costs, for electrical components based on electrical component type, electrical component rating, electrical component size, electrical component length, electrical component voltage, electrical component voltage rating, electrical component voltage capacity, or any combination thereof. In some embodiments, the electrical component upgrade cost data 108 can be associated with a transmission area. That is, different transmission areas can have different upgrade costs associated with the same electrical components. In this way, the electrical component upgrade cost data 108 can be differentiated based at least in part on an associated transmission area. Further, the system 100 can be configured to receive electrical component upgrade cost data 108 associated with each transmission area of the region. The electrical component upgrade cost data 108, in some embodiments, can be based at least in part on a voltage of the electrical component. That is, the cost of an electrical component, or any equipment, within the electrical component upgrade cost data 108 can be based at least in part on the voltage of the electrical component or equipment.

The system 100 can include a network upgrade cost application 110 configured to determine a network upgrade cost 120 for the electricity generator. The network upgrade cost application 110 can be configured to receive a user input 112. As can be appreciated, the system 100 can further include a user interface that can be configured to receive inputs from a user and display data for the user to view. As a non-limiting example, the user interface can be a screen of a computing device that is configured to display data for the user. The user interface can receive an input from a user, for example, by a touch screen, a mouse, a keyboard, or other methods of inputting data to a user interface as is known in the art. The user input 112 can include the region selection 102, the location-specific rules 106, the electrical component upgrade cost data 108, or any combination thereof. Additionally, the user input 112 can be configured to alter previously input data, such as the region selection 102, the location-specific rules 106, and electric component upgrade cost data 108, such that if there is any change associated with input data over time, the change can be accounted for via the user input 112. Further, the user input 112 can be configured to filter or alter lists or parameters received or generated by the network upgrade cost application 110, such that any data that is not properly captured via inputs to the network upgrade cost application 110 or the system 100 can be input or corrected via the user input 112. The user input 112 can be based at least in part on historical data from a data repository 116, as will be discussed in greater detail herein.

The network upgrade cost application 110 can be configured to generate an electrical component list 114. The electrical component list 114 can include at least one electrical component operating at least partially within the region. In some embodiments, the electrical component list 114 can include each electrical component operating at least partially within the region. For example, the electrical component list 114 can include a data file which includes descriptions of each transmission line, transformer, bus, and substation operating within the region, as well as corresponding electrical component types, electrical component loads, electrical component capacities, electrical component voltages, electrical component voltage ratings, electrical component voltage capacities, electrical component voltage loads, electrical component currents, electrical component current capacities, electrical component current loads, or any combination thereof.

The network upgrade cost application 110 can include the data repository 116. The data repository 116 can be configured to store data that may be used or referenced by the network upgrade cost application 110 to determine the network upgrade cost 120. For example, the data repository 116 can be configured to store the electrical component list 114. The data repository 116 can be configured to store an outcome of an overloaded electrical component determination 118, as will be discussed in greater detail herein. That is, the data repository 116 can be configured to store a description for an overloaded electrical component. In this way, the data repository 116 can be configured to store data for one or more overloaded electrical components operating at least partially within the region. The data repository 116 can be configured to store historical data. Historical data can include historical power flow data, past electrical component lists, location-specific rules, electrical component upgrade cost data, historical network upgrade cost data, historical queue data, and combinations thereof. In this way, the data repository 116 can be configured to supplement input data for the network upgrade cost application 110. Further, the data repository 116 can be configured to store the region or transmission area associated with input data, such that if a transmission area or region is currently being analyzed that has been analyzed in a past iteration of the network upgrade cost application 110, the network upgrade cost application 110 can reference corresponding data from the data repository 116 and request the user input 112 to supply any further input data needed.

The network upgrade cost application 110 can include an overloaded electrical component determination 118 configured to determine which electrical components of the electrical component list 114 are overloaded electrical components. In some embodiments, the overloaded electrical component determination 118 can be configured to determine an overloaded electrical component of the electrical component list 114 based at least in part on the location-specific rules 106. For example, the overloaded electrical component determination 118 can determine the overloaded electrical component of the electrical component list 114 based on an overload threshold associated with a transmission area. The overload threshold can be associated with a voltage, current, load, capacity, or any combination thereof of an electrical component from the electrical component list 114. Further, the overloaded electrical component determination 118 can be based at least in part on the power flow data 104. As can be appreciated, the power flow data 104 can be combined with the location-specific rules 106 to execute the overloaded electrical component determination 118 for electrical components of the electrical component list 114. In some embodiments, the overloaded electrical component determination 118 can parse through the electrical component list 114 and can determine, for each electrical component of the electrical component list, whether the electrical component is an overloaded electrical component. In some embodiments, the overloaded electrical component determination 118 can be based at least in part on historical data of the data repository 116. The overloaded electrical component determination 118 can be based at least in part on the capacity rule. That is, the network upgrade cost application 110 can be configured to execute the overloaded electrical component determination 118 based at least in part on the capacity threshold of each electrical component of the electrical component list 114. As can be appreciated, the capacity threshold may vary between transmission areas or regions. Thus, the capacity threshold can be associated with a transmission area such that the overloaded electrical component determination 118 can be based at least in part on the transmission area of each electrical component in the electrical component list 114.

The overloaded electrical component determination 118 can include determining an electrical component type based at least in part on one or more electrical bus locations and one or more electrical bus voltages. For example, the electrical component type can be a transmission line, such that a transmission line can be identified via voltages of at least two electrical buses. In some embodiments, the electrical component type can be a transformer.

The network upgrade cost application 110 can be configured to determine the network upgrade cost 120 for the electricity generator. That is, the network upgrade cost application 110 can be configured to output the network upgrade cost 120 from the overloaded electrical component determination 118. The network upgrade cost 120 can be based at least in part on a cost to upgrade the overloaded electrical component from the overloaded electrical component determination 118. As can be appreciated, the electrical component upgrade cost data 108 can be referenced to determine the upgrade cost of the overloaded electrical component from the overloaded electrical component determination 118. The network upgrade cost 120, in some embodiments, can be a sum of upgrade costs for each overloaded electrical component from the electrical component list 114 based on the overloaded electrical component determination 118 of each electrical component of the electrical component list 114. As can be appreciated, the network upgrade cost 120 can be stored by the data repository 116 for future network upgrade cost determinations.

The network upgrade cost 120, in some embodiments, can be based at least in part on the location-specific rules 106. For example, the network upgrade cost 120 can be a network upgrade cost attributed to a particular electricity generator of a plurality of electricity generators operating within the region. In this way, the location-specific rules 106, in some embodiments, can define a cost allocation of the network upgrade cost 120 to the electricity generator of the plurality of electricity generators. In some embodiments, the network upgrade cost 120 can be determined based at least in part on the funding rule. As can be appreciated, different transmission areas or regions can have different funding rules. In this way, the network upgrade cost 120 can be determined based at least in part on the transmission area of an overloaded electrical component. Further, the network upgrade cost 120 can be determined based on a quantity of power, voltage, or current supplied by the electricity generator to the overloaded electrical component. As can be appreciated, different electricity generators can thus have different network upgrade costs associated with a common overloaded electrical component based on a pro rata share of power at the overloaded electrical component from each electricity generator.

The network upgrade cost application 110 can be configured to output the network upgrade cost 120 to an output application 122. As will be appreciated, the output application 122 may include any combination of output applications as discussed herein. The output application 122 need not include each output application as detailed herein. The output application 122 merely includes examples of multiple programs, interfaces, decisions, and the like to which the network upgrade cost 120 can be applied. That is, the output application 122 may receive one or more outputs, such as the network upgrade costs 120, from the network upgrade cost application 110, and utilize the one or more outputs of the network upgrade cost application 110 as one or more inputs for at least one of the applications of the output application 122.

The output application 122 can include a cost table 124 configured to display the network upgrade cost 120 and the overloaded electrical component of the overloaded electrical component determination 118. In some embodiments, the cost table 124 can be in the form of a data file which, as can be appreciated, may be used for further data processing applications. The cost table 124 can include the electrical component list 114 and electrical component upgrade costs associated with each electrical component of the electrical component list 114. In some embodiments, the cost table 124 can include each electrical component from the electrical component list 114 determined to be an overloaded electrical component, an upgrade cost associated with each overloaded electrical component, and the network upgrade cost 120. In some embodiments, the cost table 124 can be part of a plurality of cost tables, each cost table being associated with a different region, transmission area, electricity generator, transmission provider grid operator, or any combination thereof. In this way, the network upgrade cost application 110 can be configured to update the cost table 124 to include the network upgrade cost 120.

The system 100 can be configured to receive a project capacity 126. Further, the network upgrade cost application 110 can be configured to receive the project capacity 126. The project capacity 126 can include a capacity of the electric grid required by a new project to be entered into the electric grid. As can be appreciated, the project capacity 126 can be a renewable energy project capacity of the electricity generator. The project capacity 126 can be a power value, or load value, of a potential project proposed by an electricity generator to install a project of the power value into the electric grid. In some embodiments, the network upgrade cost 120 can be determined based at least in part on the project capacity 126. The overloaded electrical component determination 118, in some embodiments, can be based at least in part on the project capacity 126. That is, the overloaded electrical component determination 118 can be configured to simulate insertion of the project capacity 126 into the electric grid at the region, and determine which electrical components of the electrical component list 114 are overloaded electrical components based at least in part on a simulated version of the region including the project capacity 126. In some embodiments, the network upgrade cost application 110 can determine the project capacity 126. Further, the network upgrade cost application 110 can determine a maximum value for the project capacity 126 based at least in part on the overloaded electrical component determination 118. In this way, the network upgrade cost application 110 can be configured to output a maximum project capacity for a minimum network upgrade cost for the region.

The output application 122 can include the geographic display 128. That is, the system 100 can be configured to generate the geographic display 128. The geographic display 128 can include a graphical interface displaying a geographic map. The geographic map can display the region, a transmission area, one or more transmission provider regions, a grid operator region, an ISO, an RTO, a country, a state, a county, or any combination thereof. The geographic map can include one or more electrical bus locations and one or more indicators for the one or more electrical buses. The one or more indicators can be based at least in part on the network upgrade cost 120. In some embodiments, an indicator for an electrical bus of the one or more electrical buses can include a color, the color being representative of the network upgrade cost associated with the electrical bus. For example, the color can be selected from a group consisting of green, yellow, and red based at least in part on the network upgrade cost associated with each electrical bus. In some embodiments, the geographic display 128 can be generated based at least in part on the project capacity 126. In this way, the one or more indicators can be a visual representation of the network upgrade costs associated with each electrical bus considering the project capacity 126 inserted at each electrical bus. For example, green can indicate no network upgrade costs, yellow can indicate low network upgrade, costs, and red can indicate high network upgrade costs. In some embodiments, red can indicate an anticipated rejection of a project including the project capacity 126; yellow can indicate an anticipated network upgrade cost for a project including the project capacity 126; and green can indicate no anticipated network upgrade cost for a project including the project capacity 126.

The output application 122 can include a queue attrition program 130 configured to determine whether one or more projects in a project queue of a transmission provider are viable projects based at least in part on the network upgrade cost 120. The queue attrition program 130 can be configured to determine a queue viability metric 132. As can be appreciated, in some embodiments, the queue viability metric 132 can be for a renewable energy project of the electricity generator. The queue viability metric 132 can be based at least in part on the network upgrade cost 120. The queue viability metric 132, in some embodiments, can be a value configured to be compared to other queue viability metric values for other projects of the electricity generator. In this way, the electricity generator may determine whether projects already in the queue will incur undesired network upgrade costs if accepted by the transmission provider based at least in part on the queue viability metric 132. In some embodiments, the queue viability metric 132 can be determined based at least in part on a total network upgrade cost discussed herein.

The queue attrition program 130 can include a project removal decision 134 configured to determine whether a project of the electricity generator in the project queue is to be removed from the project queue. In some embodiments, the queue attrition program 130 can be configured to automatically remove projects from the project queue based at least in part on the project removal decision 134 of the project. The queue attrition program 130, in some embodiments, can be configured to generate a recommendation for whether to remove the project from the project queue, which may be considered by a user such that the user can remove the project from the project queue based at least in part on the recommendation from the queue attrition program 130.

The output application 122 can be configured to determine a project location 136. In some embodiments, the project location 136 can include a substation location of a plurality of substations locations of the region, the substation being configured to be connected to the project. As can be appreciated, the project location 136 can include a location of the renewable energy project of the electricity generator. The project location 136 can be determined based at least in part on the cost table 124. In some embodiments, the project location 136 can be determined based at least in part on the network upgrade cost 120. That is, the project location 136 can be determined based at least in part on a presence of overloaded electrical components at a potential location. As can be appreciated, the project location 136 can be determined based at least in part on the project capacity 126, the network upgrade cost 120, and the queue viability metric 132. In this way, a project having the project location 136 can be sited at or near a substation based on the network upgrade cost 120 and the queue viability metric 132 associated with the substation.

The system 100 can include an application that can be in communication with the user interface and a machine learning model. As non-limiting examples, the application can be an extension of a browser, a software program, a program or feature of a kernel of the system, or any computer application that can perform the functions described herein.

As will be appreciated, as the machine learning model can be trained and more accurate over time, the amount of frequency of user inputs of the user input 112 can be reduced. In other words, as the machine learning model can become more accurate over time, the need for human oversight of the machine learning model can decrease and the machine learning model can operate largely unsupervised.

The machine learning model can be or include a neural network, a recurrent neural network, a Long Short-Term Memory (LSTM) network, a bi-direction LSTM network, a Conditional Random Fields (CRF) network, an LSTM-CRF network, a Bi-LSTM-CRF network, or other suitable machine learning models. In some embodiments, the machine learning model can employ a gradient boosting model, a light gradient boosting model, or similar models known in the art.

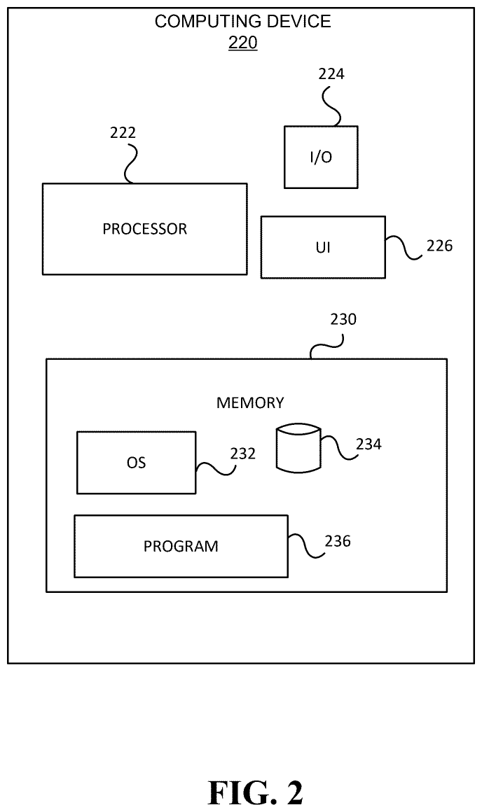

FIG. 2 illustrates an example computing device configured to avoid basis risk for renewable energy sites, in accordance with examples of the disclosed technology. As will be appreciated by one of skill in the art, the computing device 220 can be configured to include all or some of the features described in relation to the system 100. As shown, the computing device 220 may include a processor 222, an input/output (“I/O”) device 224, a memory 230 containing an operating system (“OS”) 232 and a program 236. In certain example implementations, the computing device 220 may be a single server or may be configured as a distributed computer system including multiple servers or computers that interoperate to perform one or more of the processes and functionalities associated with the disclosed embodiments. In some embodiments, computing device 220 may be one or more servers from a serverless or scaling server system. In some embodiments, the computing device 220 may further include a peripheral interface, a transceiver, a mobile network interface in communication with the processor 222, a bus configured to facilitate communication between the various components of the computing device 220, and a power source configured to power one or more components of the computing device 220.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth^{TM} port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 222 to communicate with other devices via wired or wireless networks, whether local or wide area, private or public, as known in the art. A power source may be configured to provide an appropriate alternating current (AC) or direct current (DC) to power components.

The processor 222 may include one or more of a microprocessor, microcontroller, digital signal processor, co-processor or the like or combinations thereof capable of executing stored instructions and operating upon stored data. The memory 230 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 230.

The processor 222 may be one or more known processing devices, such as, but not limited to, a microprocessor from the Pentium™ family manufactured by Intel™ or the Turion™ family manufactured by AMD™. The processor 222 may constitute a single core or multiple core processor that executes parallel processes simultaneously. For example, the processor 222 may be a single core processor that is configured with virtual processing technologies. In certain embodiments, the processor 222 may use logical processors to simultaneously execute and control multiple processes. The processor 222 may implement virtual machine technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the computing device 220 may include one or more storage devices configured to store information used by the processor 222 (or other components) to perform certain functions related to the disclosed embodiments. In one example, the computing device 220 may include the memory 230 that includes instructions to enable the processor 222 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

In one embodiment, the computing device 220 may include a memory 230 that includes instructions that, when executed by the processor 222, perform one or more processes consistent with the functionalities disclosed herein. Methods, systems, and articles of manufacture consistent with disclosed embodiments are not limited to separate programs or computers configured to perform dedicated tasks. For example, the computing device 220 may include the memory 230 that may include one or more programs 236 to perform one or more functions of the disclosed embodiments.

The processor 222 may execute one or more programs located remotely from the computing device 220. For example, the computing device 220 may access one or more remote programs that, when executed, perform functions related to disclosed embodiments.

The memory 230 may include one or more memory devices that store data and instructions used to perform one or more features of the disclosed embodiments. The memory 230 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 230 may include software components that, when executed by the processor 222, perform one or more processes consistent with the disclosed embodiments. In some examples, the memory 230 may include a database 234 configured to store various data described herein. For example, the database 234 can be the data repository 116.

The computing device 220 may also be communicatively connected to one or more memory devices (e.g., databases) locally or through a network. The remote memory devices may be configured to store information and may be accessed and/or managed by the computing device 220. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The computing device 220 may also include one or more I/O devices 224 that may comprise one or more user interfaces 226 (e.g., user interface) for receiving signals or input from devices and providing signals or output to one or more devices that allow data to be received and/or transmitted by the computing device 220. For example, the computing device 220 may include interface components, which may provide interfaces to one or more input devices, such as one or more keyboards, mouse devices, touch screens, track pads, trackballs, scroll wheels, digital cameras, microphones, sensors, and the like, that enable the computing device 220 to receive data from a user.

In example embodiments of the disclosed technology, the computing device 220 may include any number of hardware and/or software applications that are executed to facilitate any of the operations. The one or more I/O devices 224 may be utilized to receive or collect data and/or user instructions from a wide variety of input devices. Received data may be processed by one or more computer processors as desired in various implementations of the disclosed technology and/or stored in one or more memory devices.

While the computing device 220 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the computing device 220 may include a greater or lesser number of components than those illustrated.

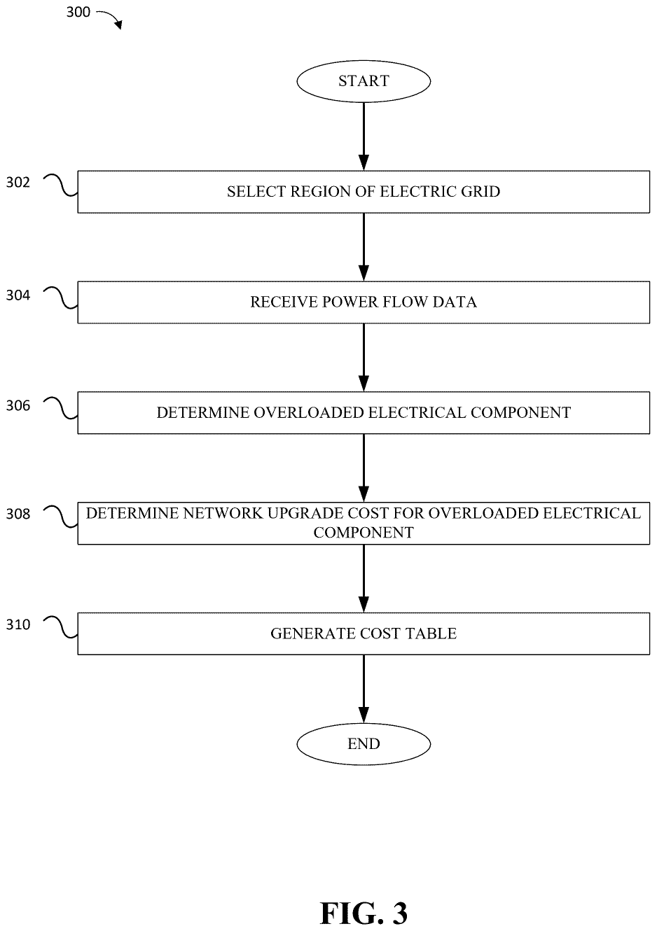

FIG. 3 is a flow diagram illustrating a method 300 for determining network upgrade costs for an electricity generator. The method 300 can include selecting 302 a region of the electric grid. The region, as can be appreciated, can be selected via any embodiments of the region selection 102 as discussed herein. The region can include any geographic area within an electric grid. In some embodiments, the region can be selected based at least in part on a region of an ISO, RTO, or any other grid operator or transmission authority. In some embodiments, the region can be selected based at least in part on a region defined by a project queue. That is, the region can be selected based at least in part on one or more transmission providers. As will be discussed in greater detail herein, the region can include at least one transmission area. As discussed in greater detail herein, the at least one transmission area can be associated with at least one transmission provider. In this way, in some embodiments, a transmission area can be defined by a geographic area of a transmission provider. In some embodiments, the region can define a geographic area that includes one or more electric grid elements operating within the region. The region may be defined by one or more electric grid elements. For example, the region can include a substation. Further, the region can include a substation and one or more electrical components in connection with the substation. In some embodiments, the region can include an electrical bus and one or more electrical components in connection with the electrical bus. In some embodiments, the region can include a renewable energy project and one or more electrical components in connection with the renewable energy project. Additionally, the region can include the renewable energy project and each electrical component, including transmission lines and transformers, as well as each substation and each electrical bus in communication with the renewable energy project.

The method 300 can include receiving 304 power flow data. The power flow data can include any embodiments of the power flow data 104 discussed herein. Power flow data, or power flow simulation data, can be defined as understood herein. For example, power flow data can include voltages, currents, loads, and generation at nodes, buses, substations, and electrical components within the electric grid. For example, the power flow data can include one or more electrical bus locations, one or more electrical bus voltages, and one or more power flows. In some embodiments, the power flow data received can be associated with the region. That is, the power flow data can be representative of electric grid elements operating, at least partially, within the region. In some embodiments, receiving 304 the power flow data can include selecting, from the power flow data, power flow data associated with the region. In this way, the power flow data, and outputs based thereupon, can be based at least in part on the region.

The method 300 can include determining 306 an overloaded electrical component. As can be appreciated, determining 306 an overloaded electrical component can include any embodiments of the overloaded electrical component determination 118 discussed herein. Further, the overloaded electrical component can be determined from a list of electrical components, including any embodiments of the electrical component list 114 discussed herein. Determining 306 the overloaded electrical component can include generating a list of electrical components operating at least partially within the region. Determining the list of electrical components can include determining an electrical component type based at least in part on the one or more electrical bus locations and the one or more electrical bus voltages. Further, the overloaded electrical component can be determined based at least in part on one or more power flows and the electrical component type. The overloaded electrical component can be determined based at least in part on the power flow data. The overloaded electrical component can be determined based at least in part electrical component upgrade cost data, as discussed in greater detail herein. The overloaded electrical component can be determined based at least in part on location-specific rules, as will be discussed in greater detail herein. In some embodiments, the overloaded electrical component can be determined based at least in part on a project capacity for an energy generation project, as will be discussed in greater detail herein. As discussed herein, the energy generation project, in any methods discussed herein, can be a renewable energy project. The overloaded electrical component can be part of a plurality of overloaded electrical components, such that determining 306 the overloaded electrical component can include determining a plurality of overloaded electrical components. In some embodiments, the overloaded electrical component can be part of one or more overloaded electrical components of a plurality of electrical components operating at least partially within the region. The overloaded electrical component can be determined based at least in part on the electrical component type, a voltage of the electrical component, a current of the electrical component, or any combination thereof. As can be appreciated, an electrical component can be determined to be overloaded based at least in part on a voltage or current of the electrical component being greater than a threshold, such that the threshold is based at least in part on the location-specific rules discussed herein.

The method 300 can include determining 308 a network upgrade cost for the overloaded electrical component. The network upgrade cost can be in the form of a dollar value associated with a cost of replacing one or more electrical components identified as overloaded electrical components. In some embodiments, the network upgrade cost can be described in $/MW, or dollars per power output. In some embodiments, the network upgrade cost can be described in $/MWh, or dollars per power output per hour. As can be appreciated, the network upgrade cost can include any embodiments of the network upgrade cost 120 discussed herein. In some embodiments, the network upgrade cost can be associated with the overloaded electrical component. That is, the network upgrade cost can be a cost to replace the overloaded electrical component. In some embodiments, the network upgrade cost can be associated with one or more overloaded electrical components. That is, the network upgrade cost can be a cost to replace one or more overloaded electrical components. Further, the network upgrade cost can be associated with all overloaded electrical components within the region. That is, the network upgrade cost can be a cost to replace each overloaded electrical component within the region. The network upgrade cost, in some embodiments, can be determined by the electricity generator based at least in part on the power flow data. As can be appreciated, network upgrade costs can be administered by a transmission provider based on a project in a project queue of the transmission provider. That is, the network upgrade cost of the disclosed technology can seek to anticipate a network upgrade cost ultimately administered or authorized by the transmission provider. The network upgrade cost, as determined by the electricity generator, can be further used in a plurality of output applications, as discussed for the output application 122. In some embodiments, as will be discussed in greater detail herein, the network upgrade cost can be determined based at least in part on a project capacity. In this way, the network upgrade cost can represent an anticipated cost of injecting a new energy generation project into the electric grid at a location based at least in part on the power flow data of the region. Furthermore, the network upgrade cost can be associated with a particular location for an energy generation project within the region. That is, the network upgrade cost can be associated with an electrical bus at an electrical bus location, and electrical components in connection with the electrical bus. In some embodiments, the network upgrade cost can be representative of one or more electrical buses, and each overloaded electrical component associated with the one or more electrical buses. In some embodiments, the network upgrade cost can be based at least in part on each overloaded electrical component associated with every electrical bus operating within the region. In this way, the network upgrade cost can be a single value representative of the entire region. In other embodiments, the network upgrade cost can be part of multiple network upgrade costs, each associated with an overloaded electrical component of multiple overloaded electrical components within the region. In this way, the network upgrade cost can be tied to the overloaded electrical component that requires replacing.

The method 300 can include generating 310 a cost table. The cost table can include any embodiments of the cost table 124 discussed herein. In some embodiments, the cost table can include the overloaded electrical component and the network upgrade cost. The cost table can include one or more overloaded electrical components and the network upgrade cost. As can be appreciated, the cost table can include one or more overloaded electrical components and one or more network upgrade costs, each network upgrade cost associated with an overloaded electrical component. The cost table can include one or more overloaded electrical components such that the cost table can include data related to the one or more overloaded electrical components. That is, the cost table can include an electrical component type associated with the overloaded electrical component. In some embodiments, the cost table can include power flow data associated with the overloaded electrical component. As can be appreciated, generating 310 the cost table can include altering an electrical component list, such as the electrical component list 314. Altering the electrical component list can include identifying the one or more overloaded electrical components in the electrical component list, inserting the network upgrade cost into the electrical component list, and converting a format of the electrical component list to generate the cost table. As can be appreciated, the cost table can be any table, spreadsheet, or similar data representation as understood in the art. Further, the cost table, or table, can be used for further processing in output applications as understood in the art and as discussed herein.

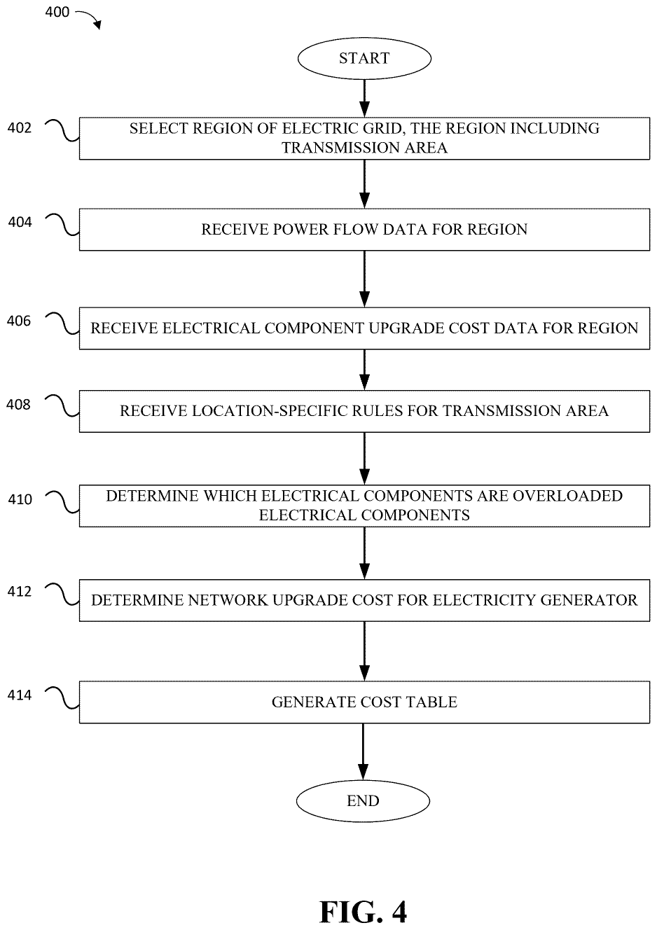

FIG. 4 is another flow diagram illustrating an exemplary method 400 for determining network upgrade costs for an electricity generator. The method 400 can include selecting 402 a region of the electric grid, the region including a transmission area. The transmission area, as discussed herein, can be any geographic area defined by transmission authorities, transmission providers, electricity generators, electrical buses, or similar areas of the electric grid characterized by having common regulations for upgrade cost allocation. Specifically, the transmission area can be a geographic region operated by a transmission provider. For example, the location-specific rules discussed herein can be unique to a transmission area, in that each transmission area can be defined based at least in part on respective location-specific rules. That is, the location-specific rules, as discussed herein, can be associated with the transmission provider of the transmission area. The region can include at least one transmission area. Further, the region can include a plurality of transmission areas.

The method 400 can include receiving 404 power flow data for the region. The power flow data can include any embodiments of power flow data discussed herein. In some embodiments, the power flow data can be associated with a transmission area. In this way, receiving 404 the power flow data for the region can include receiving power flow data for each transmission area of the region. The method 400 can include receiving 406 electrical component upgrade cost data for the region. The electrical component upgrade cost data can include any embodiments of the electrical component upgrade cost data 108 discussed herein. The electrical component upgrade cost data can include cost values for upgrading electrical components. As can be appreciated, the electrical component upgrade cost data can include cost values for upgrading an overloaded electrical component based at least in part on electrical component type and power flow data associated with the overloaded electrical component. As understood in the art, the rating of an electrical component, as well as the type, load, capacity, and similar parameters can be relevant to an associated cost for upgrade. Further, the electrical component upgrade cost data can be based at least in part on the transmission area. More specifically, a transmission area of the region can include its own unique electrical component upgrade cost data. In this way, the electrical component upgrade costs data can be based at least in part on the region.

The method 400 can include receiving 408 location-specific rules for the transmission area. As can be appreciated, the location-specific rules can include any embodiments of the location-specific rules 106 as discussed herein. The location-specific rules can include regulations associated with a transmission area that relate to defining an electrical component, determining an overloaded electrical component, allocating network upgrade costs, or more generally to distribution, sale, and output of electricity within the transmission area. In some embodiments, the location-specific rules can include a capacity rule. The capacity rule can define a capacity threshold for an electrical component to be an overloaded electrical component. As can be appreciated, the capacity threshold can be an upper bound value for a voltage, current, load, or generation of an electrical component, and may be based at least in part on the electrical component type. The location-specific rules can include a funding rule. The funding rule can define if an overloaded electrical component requires funding from the generator. The funding rule, in some embodiments, may define, for a transmission area, which electricity generators using an electrical component would owe an upgrade cost associated with the electrical component if the electrical component were to need replacement. That is, if the electrical component is an overloaded electrical component, the funding rule can determine which electricity generators owe a cost of replacement, or network upgrade cost. In some embodiments, the funding rule can define a specific dollar amount associated with an electrical component to be owed by each electricity generator using the electrical component. Similarly, in some embodiments, the funding rule can define a dollar per megawatt or dollar per megawatt hour amount associated with an electrical component to be owed by each electricity generator using the electrical component. In some embodiments, the funding rule can allocate a pro rata share of the network upgrade cost to each electricity generator using the overloaded electrical component based at least in part on a proportion of power, or load, from each electricity generator.

The method 400 can include determining 410 which electrical components are overloaded electrical components. The overloaded electrical components can be determined based at least in part on the power flow data. The overloaded electrical components can be determined based at least in part on the capacity rule, or the capacity threshold. In some embodiments, determining 410 which electrical components are overloaded electrical components can include determining an electrical component type of the overloaded electrical component. As discussed herein, the electrical component type can be determined based at least in part on one or more electrical bus locations and one or more electrical bus voltages. For example, a transmission line can be determined via comparing voltages at two electrical buses which the transmission line, or electrical component, connects. Further, the overloaded electrical component can be determined based at least in part on one or more power flows. For example, if a transmission current of an electrical component is above the capacity threshold, then the electrical component can be identified as an overloaded electrical component. As can be appreciated, the overloaded electrical component can be determined based at least in part on the electrical component type. For example, different electrical component types may have different capacity thresholds according to the location-specific rules, such that determining whether an electrical component meets criteria for an overloaded electrical component according to the capacity threshold can include determining the electrical component type.

The method 400 can include determining 412 a network upgrade cost for the electricity generator. The network upgrade cost can include any embodiment of the network upgrade cost 120, or any network upgrade costs discussed herein. The network upgrade cost can be determined based at least in part on the funding rule. That is, determining 412 the network upgrade cost can include determining if at least one overloaded electrical component requires funding from the electricity generator based at least in part on the funding rule. Further, the network upgrade cost can be determined based at least in part on a pro rata share of power at the at least one overloaded electrical component from the electricity generator. The network upgrade cost can be based at least in part on the electricity component upgrade cost data. That is, the network upgrade cost can be determined by attributing costs from the electricity component upgrade cost data to each overloaded electrical component based at least in part on the location-specific rules. In this way, the network upgrade cost can be specific to the electricity generator. In other embodiments, the network upgrade cost can be specific to the region. In some embodiments, the network upgrade cost can be based on a transmission line length. That is, the network upgrade cost can be determined based at least in part on calculating a cost associated with replacing a transmission line of the transmission line length, such that the associated cost is based at least in part on the electricity upgrade cost data. In some embodiments, and as discussed herein, the network upgrade cost can be determined based at least in part on a project capacity. In this way, the network upgrade cost can be simulated by an electricity generator to provide a theoretical network upgrade cost if a project of the project capacity were to be submitted to a project queue of a transmission provider associated with the region.

As before, the method 400 can include generating 414 a cost table. The cost table can include any embodiments of cost tables, or tables, discussed herein.

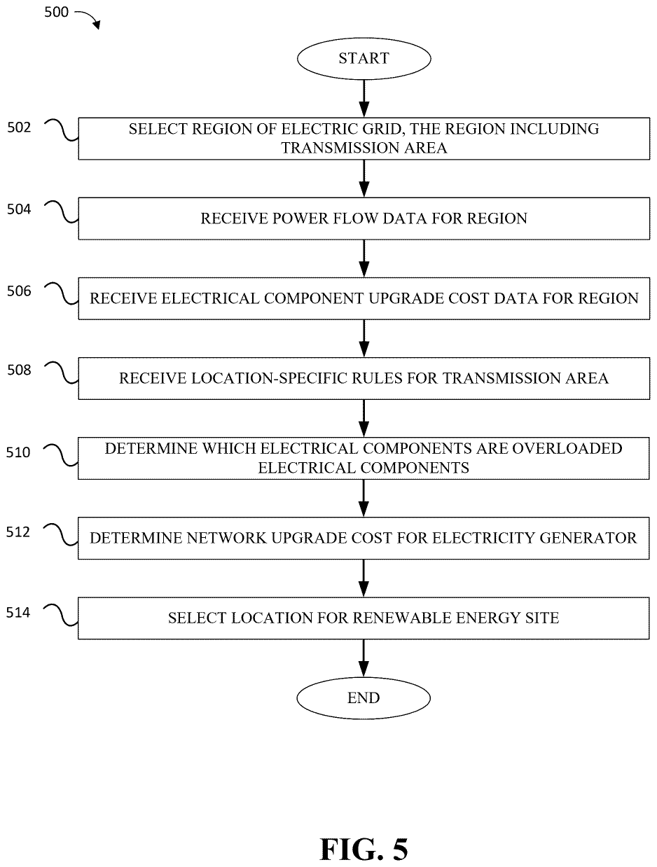

FIG. 5. is yet another flow diagram illustrating an exemplary method 500 for determining network upgrade costs for a renewable energy project of an electricity generator. As before, the method 500 can include selecting 502 a region of the electric grid, the region including a transmission area. As before, the method 500 can include receiving 504 power flow data for the region. As before, the method 500 can include receiving 506 electrical component upgrade cost data for the region. As before, the method 500 can include receiving 508 location-specific rules for the transmission area. As before, the method 500 can include determining 510 which electrical components are overloaded electrical components. As before, the method 500 can include determining 512 a network upgrade cost for the electricity generator. Additionally, the method 500 can include selecting 514 a location for a renewable energy site. As can be appreciated, selecting 514 the location for the renewable energy site can include selecting a location, or site, for a renewable energy project for an electricity generator. In some embodiments, the renewable energy site can be selected based at least in part on the project capacity of the renewable energy site. Further, the renewable energy site can be selected based at least in part on the network upgrade cost. The renewable energy site, in some embodiments, can be selected based at least in part on the network upgrade costs incurred by the project capacity being inserted into the electric grid at the renewable energy site. In this way, the electricity generator can select a site for the renewable energy project based at least in part on a network upgrade cost determined at least in part by the project capacity.

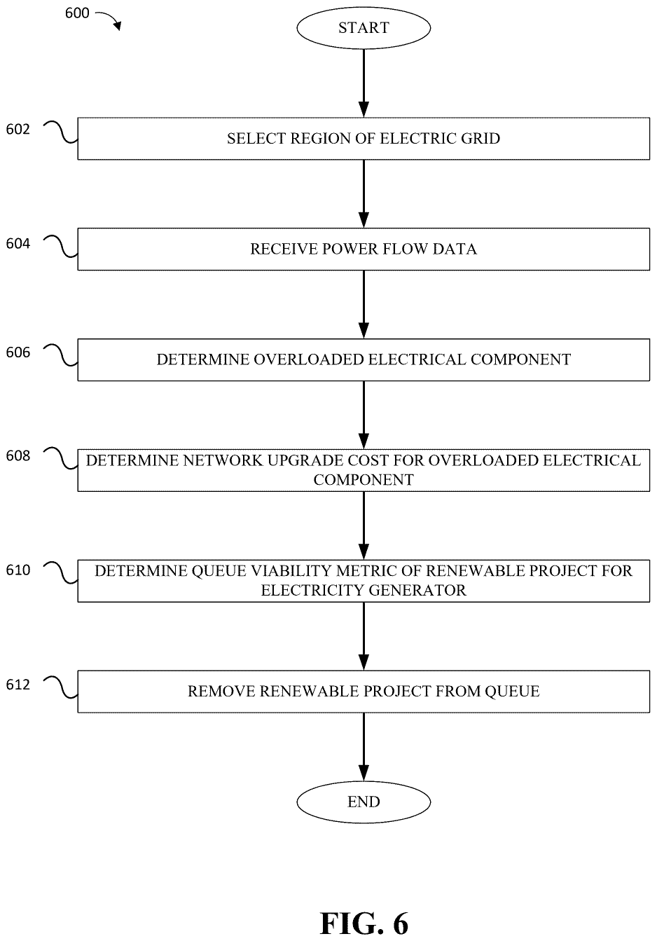

FIG. 6 is yet another flow diagram illustrating an exemplary method 600 for determining network upgrade costs for an electricity generator. As before, the method 600 can include selecting 602 a region of the electric grid. As before, the method 600 can include receiving 604 power flow data. As before, the method 600 can include determining 606 an overloaded electrical component. As before, the method 600 can include determining 608 a network upgrade cost for the overloaded electrical component. Additionally, the method 600 can include determining 610 a queue viability metric of a renewable energy project for the electricity generator. The queue viability metric can include any embodiments of the queue viability metric 132 discussed herein. In some embodiments, the queue viability metric can include one or more cost thresholds for the renewable energy project. That is, the queue viability metric can define an upper bound for the network upgrade cost associated with the renewable energy project to be acceptable. The method 600 can include removing 612 a renewable energy project from a project queue. As can be appreciated, the renewable energy project can be removed by the electricity generator from the project queue based at least in part on the queue viability metric. For example, if the queue viability metric for a renewable energy project is below predetermined threshold, then the renewable energy project can be automatically removed from the project queue. In another example embodiment, if the network upgrade cost for the renewable energy project is greater than a cost threshold set by the queue viability metric, then the renewable energy project can be automatically removed from the project queue.

In some embodiments, multiple iterations of the method 600 can be performed to narrow down a number of renewable energy projects which meet criteria set by the queue viability metric. For example, in each iteration, the selected region can be altered to exclude projects from previous iterations that did not meet criteria set by the queue viability metric. In this way, the method 600 can further include iteratively determining one or more permissible renewable energy projects by altering the region each iteration.

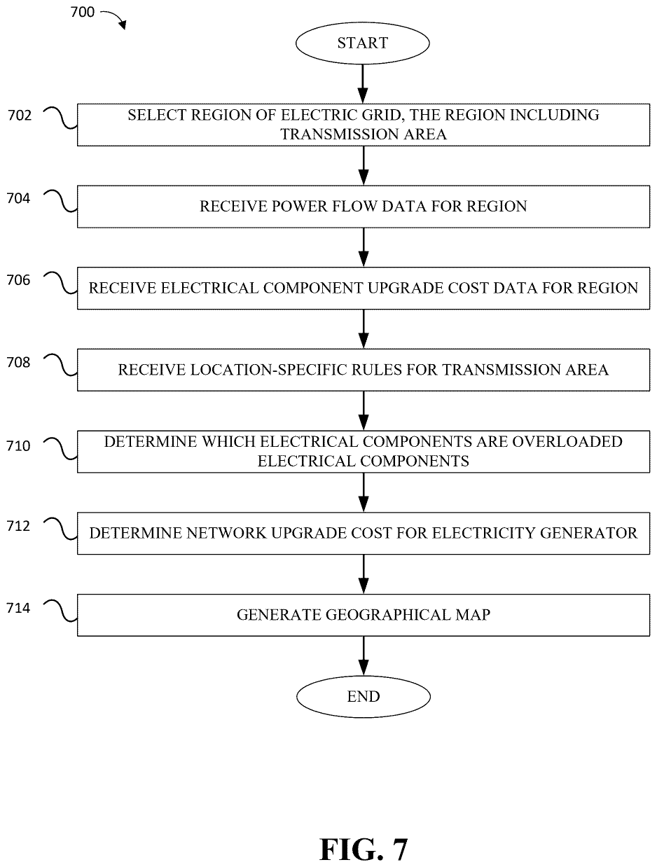

FIG. 7 is yet another flow diagram illustrating an exemplary method 700 for determining network upgrade costs for a renewable energy project of an electricity generator. As before, the method 700 can include selecting 702 a region of the electric grid, the region including a transmission area. As before, the method 700 can include receiving 704 power flow data for the region. As before, the method 700 can include receiving 706 electrical component upgrade cost data for the region. As before, the method 700 can include receiving 708 location-specific rules for the transmission area. As before, the method 700 can include determining 710 which electrical components are overloaded electrical components. As before, the method 700 can include determining 712 a network upgrade cost for the electricity generator. Additionally, the method 700 can include generating 714 a geographical map. In some embodiments, generating 714 the geographic map can include generating a graphical interface displaying the geographical map. As can be appreciated, the graphical interface can be any graphical interface known in the art, such as any screen or display of any computing device discussed herein. The geographical map can include any embodiments of the geographic display 128 discussed herein. The geographical map can include one or more indicators located at one or more electrical bus locations. In this way, the one or more indicators can display a network upgrade cost associated with the one or more electrical buses. For example, the one or more indicators may each display a color indicating the network upgrade cost associated with each electrical bus. That is, the one or more indicators can be based at least in part on the network upgrade cost. In some embodiments, the one or more indicators can be based at least in part on the project capacity, as discussed for the project capacity 126 herein.

The disclosed technology can be further understood according to the following clauses:

Clause 1: A method for determining upgrade costs of overloaded components for an electricity generator, comprising: selecting a region of an electric grid, the region comprising at least one transmission area; receiving power flow data for the region; receiving electrical component upgrade cost data for the region; receiving location-specific rules for the at least one transmission area; determining which electrical components operating at least partially within the region are overloaded electrical components based at least in part on the power flow data; determining a network upgrade cost for at least one overloaded electrical component of the region for the electricity generator, the network upgrade cost based at least in part on the electrical component upgrade cost data and the location-specific rules; and generating a table comprising the network upgrade cost.

Clause 2: The method of Clause 1, wherein the region is selected from a group consisting of: an independent system operator (ISO) region, a regional transmission authority (RTO) region, an electricity generator-owned region, and a transmission provider region.

Clause 3: The method of Clause 1, wherein the location-specific rules for the at least one transmission area comprise: a capacity rule defining a capacity threshold for an electrical component to be an overloaded electrical component; and a funding rule defining if an overloaded electrical component requires funding from the electricity generator.

Clause 4: The method of Clause 3, wherein determining a network upgrade cost for at least one overloaded electrical component comprises: determining if at least one overloaded electrical component requires funding from the electricity generator based at least in part on the funding rule; and determining the network upgrade cost for the at least one overloaded electrical component based at least in part on a pro rata share of power at the at least one overloaded component from the electricity generator.

Clause 5: The method of Clause 1, wherein the power flow data comprises: one or more electrical bus locations; one or more electrical bus voltages; and one or more power flows, wherein determining which electrical components operating at least partially within the region are overloaded electrical components comprises: determining an electrical component type based at least in part on the one or more electrical bus locations and the one or more electrical bus voltages; and determining an overloaded electrical component based at least in part on the one or more power flows and the electrical component type.

Clause 6: The method of Clause 1, further comprising receiving a project capacity.

Clause 7: The method of Clause 6, further comprising generating a graphical interface displaying a geographical map, wherein the geographical map comprises one or more electrical bus locations and one or more indicators at the one or more electrical bus locations, wherein the one or more indicators are based at least in part on the network upgrade cost.

Clause 8: The method of Clause 6, further comprising selecting a location for a renewable energy project based at least in part on the project capacity and the network upgrade cost, wherein the network upgrade cost is determined further based at least in part on the project capacity.

Clause 9: A system comprising: one or more processors; and memory comprising instructions that when executed by the one or more processors, cause the one or more processors to: select a region of an electric grid, the region comprising at least one transmission area; receive power flow data for the region comprising: one or more electrical bus locations; one or more electrical bus voltages; and one or more power flows; receive electrical component upgrade cost data for the region; receive location-specific rules for the at least one transmission area; determine which electrical components operating at least partially within the region are overloaded electrical components based at least in part on the power flow data; determine a network upgrade cost for at least one overloaded electrical component of the region for an electricity generator, the network upgrade cost based at least in part on the electrical component upgrade cost data and the location-specific rules; and generate a table comprising the network upgrade cost.

Clause 10: The system of Clause 9, wherein the region is selected from a group consisting of: an independent system operator (ISO) region, a regional transmission authority (RTO) region, an electricity generator-owned region, and a transmission provider region.

Clause 11: The system of Clause 9, wherein the location-specific rules for the at least one transmission area comprise: a capacity rule defining a capacity threshold for an electrical component to be an overloaded electrical component; and a funding rule defining if an overloaded electrical component requires funding from the electricity generator.

Clause 12: The system of Clause 11, wherein determining a network upgrade cost for at least one overloaded electrical component comprises: determining if at least one overloaded electrical component requires funding from the electricity generator based at least in part on the funding rule; and determining the network upgrade cost for the at least one overloaded electrical component based at least in part on a pro rata share of power at the at least one overloaded component from the electricity generator.

Clause 13: The system of Clause 11, wherein determining which electrical components operating at least partially within the region are overloaded electrical components comprises: determining an electrical component type based at least in part on the one or more electrical bus locations and the one or more electrical bus voltages; and determining an overloaded electrical component based at least in part on the one or more power flows and the electrical component type.

Clause 14: The system of Clause 13, wherein the instructions, when executed by the one or more processors, further cause the one or more processors to: receive a project capacity; and generate a graphical interface displaying a geographical map, wherein the geographical map comprises one or more electrical bus locations and one or more indicators at the one or more electrical bus locations, wherein the one or more indicators are based at least in part on the network upgrade cost.

Clause 15: The system of Clause 13, wherein the instructions, when executed by the one or more processors, further cause the one or more processors to select a location for a renewable energy project based at least in part on a project capacity and the network upgrade cost, wherein the network upgrade cost is determined further based at least in part on the project capacity.

Clause 16: A method comprising: selecting a region of an electric grid; receiving power flow data for the region; determining an overloaded electrical component of a plurality of electrical components disposed at least partially in the region based at least in part on the power flow data; determining a network upgrade cost for the overloaded electrical component; determining a queue viability metric of a renewable energy project from an electrical generator based at least in part on the network upgrade cost; and removing the renewable energy project from a project queue based at least in part on the queue viability metric.

Clause 17: The method of Clause 16, wherein the overloaded electrical component is part of a plurality of overloaded electrical components, wherein determining the network upgrade cost for the overloaded electrical component comprises determining a total network upgrade cost for the plurality of overloaded electrical components.

Clause 18: The method of Clause 17, wherein the queue viability metric is determined based at least in part on the total network upgrade cost.

Clause 19: The method of Clause 16, wherein the region comprises one or more transmission areas, wherein the one or more transmission areas comprise one or more location-specific rules, wherein the network upgrade cost is determined based at least in part on the one or more location-specific rules.

Clause 20: The method of Clause 19, wherein determining a network upgrade cost for the overloaded electrical component comprises: determining if at least one overloaded electrical component requires funding from the electricity generator based at least in part on the one or more location-specific rules; and determining the network upgrade cost for the overloaded electrical component based at least in part on a pro rata share of power at the overloaded component from the electricity generator.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

What is claimed is:

1. A method for determining upgrade costs of overloaded components for an electricity generator, comprising:
selecting a region of an electric grid, the region comprising at least one transmission area;
receiving power flow data for the region;
receiving electrical component upgrade cost data for the region;
receiving location-specific rules for the at least one transmission area;
determining which electrical components operating at least partially within the region are overloaded electrical components based at least in part on the power flow data;
determining a network upgrade cost for at least one overloaded electrical component of the region for the electricity generator, the network upgrade cost based at least in part on the electrical component upgrade cost data and the location-specific rules; and
generating a table comprising the network upgrade cost.

2. The method of claim 1, wherein the region is selected from a group consisting of: an independent system operator (ISO) region, a regional transmission authority (RTO) region, an electricity generator-owned region, and a transmission provider region.

3. The method of claim 1, wherein the location-specific rules for the at least one transmission area comprise:
a capacity rule defining a capacity threshold for an electrical component to be an overloaded electrical component; and
a funding rule defining if an overloaded electrical component requires funding from the electricity generator.

4. The method of claim 3, wherein determining a network upgrade cost for at least one overloaded electrical component comprises:
determining if at least one overloaded electrical component requires funding from the electricity generator based at least in part on the funding rule; and
determining the network upgrade cost for the at least one overloaded electrical component based at least in part on a pro rata share of power at the at least one overloaded component from the electricity generator.

5. The method of claim 1, wherein the power flow data comprises:
one or more electrical bus locations;
one or more electrical bus voltages; and
one or more power flows,
wherein determining which electrical components operating at least partially within the region are overloaded electrical components comprises:
determining an electrical component type based at least in part on the one or more electrical bus locations and the one or more electrical bus voltages; and
determining an overloaded electrical component based at least in part on the one or more power flows and the electrical component type.

6. The method of claim 1, further comprising receiving a project capacity.

7. The method of claim 6, further comprising generating a graphical interface displaying a geographical map, wherein the geographical map comprises one or more electrical bus locations and one or more indicators at the one or more electrical bus locations, wherein the one or more indicators are based at least in part on the network upgrade cost.

8. The method of claim 6, further comprising selecting a location for a renewable energy project based at least in part on the project capacity and the network upgrade cost, wherein the network upgrade cost is determined further based at least in part on the project capacity.

9. A system comprising:
one or more processors; and
memory comprising instructions that when executed by the one or more processors, cause the one or more processors to:
select a region of an electric grid, the region comprising at least one transmission area;
receive power flow data for the region comprising:
one or more electrical bus locations;
one or more electrical bus voltages; and
one or more power flows;
receive electrical component upgrade cost data for the region;
receive location-specific rules for the at least one transmission area;
determine which electrical components operating at least partially within the region are overloaded electrical components based at least in part on the power flow data;
determine a network upgrade cost for at least one overloaded electrical component of the region for an electricity generator, the network upgrade cost based at least in part on the electrical component upgrade cost data and the location-specific rules; and
generate a table comprising the network upgrade cost.

10. The system of claim 9, wherein the region is selected from a group consisting of: an independent system operator (ISO) region, a regional transmission authority (RTO) region, an electricity generator-owned region, and a transmission provider region.

11. The system of claim 9, wherein the location-specific rules for the at least one transmission area comprise:
a capacity rule defining a capacity threshold for an electrical component to be an overloaded electrical component; and
a funding rule defining if an overloaded electrical component requires funding from the electricity generator.

12. The system of claim 11, wherein determining a network upgrade cost for at least one overloaded electrical component comprises:
determining if at least one overloaded electrical component requires funding from the electricity generator based at least in part on the funding rule; and
determining the network upgrade cost for the at least one overloaded electrical component based at least in part on a pro rata share of power at the at least one overloaded component from the electricity generator.

13. The system of claim 11, wherein determining which electrical components operating at least partially within the region are overloaded electrical components comprises:
determining an electrical component type based at least in part on the one or more electrical bus locations and the one or more electrical bus voltages; and
determining an overloaded electrical component based at least in part on the one or more power flows and the electrical component type.

14. The system of claim 13, wherein the instructions, when executed by the one or more processors, further cause the one or more processors to:
receive a project capacity; and
generate a graphical interface displaying a geographical map, wherein the geographical map comprises one or more electrical bus locations and one or more indicators at the one or more electrical bus locations, wherein the one or more indicators are based at least in part on the network upgrade cost.

15. The system of claim 13, wherein the instructions, when executed by the one or more processors, further cause the one or more processors to select a location for a renewable energy project based at least in part on a project capacity and the network upgrade cost, wherein the network upgrade cost is determined further based at least in part on the project capacity.

16. A method comprising:
selecting a region of an electric grid;
receiving power flow data for the region;
determining an overloaded electrical component of a plurality of electrical components disposed at least partially in the region based at least in part on the power flow data;
determining a network upgrade cost for the overloaded electrical component;
determining a queue viability metric of a renewable energy project from an electrical generator based at least in part on the network upgrade cost; and
removing the renewable energy project from a project queue based at least in part on the queue viability metric.

17. The method of claim 16, wherein the overloaded electrical component is part of a plurality of overloaded electrical components, wherein determining the network upgrade cost for the overloaded electrical component comprises determining a total network upgrade cost for the plurality of overloaded electrical components.

18. The method of claim 17, wherein the queue viability metric is determined based at least in part on the total network upgrade cost.

19. The method of claim 16, wherein the region comprises one or more transmission areas, wherein the one or more transmission areas comprise one or more location-specific rules, wherein the network upgrade cost is determined based at least in part on the one or more location-specific rules.

20. The method of claim 19, wherein determining a network upgrade cost for the overloaded electrical component comprises:
determining if at least one overloaded electrical component requires funding from the electricity generator based at least in part on the one or more location-specific rules; and
determining the network upgrade cost for the overloaded electrical component based at least in part on a pro rata share of power at the overloaded component from the electricity generator.
